(19) United States
(12) Patent Application Publication
(10) Pub. No.: US 2022/0281423 A1
(43) Pub. Date: Sep. 8, 2022

(54) WHEELCHAIR WHEEL LOCK PLATE ASSEMBLY

(71) Applicant: Push Lox, LLC, St. Peters, MO (US)

(72) Inventor: Clayton Braun, St. Peters, MO (US)

(73) Assignee: Push Lox, LLC, St. Peters, MO (US)

(21) Appl. No.: 17/669,436

(22) Filed: Feb. 11, 2022

Related U.S. Application Data
(60) Provisional application No. 63/156,656, filed on Mar. 4, 2021.

(51) Int. Cl. B60T 1/00; A61G 5/10

(52) U.S. Cl. CPC B60T 1/005; A61G 5/1024

(57) ABSTRACT

A plate assembly for a wheelchair having a wheel lock system for a spoked wheel. The wheel lock assembly includes an actuator that moves a lock-pin between locking and unlocking positions with the wheel. The plate assembly has three generally flat plates attached together by a double ring of bolts with pliant nuts. The first plate is metal and releasably engages the lock-pin. The other two plates are made of pliant material, and mate from opposite sides of the spokes to form elongated radial channels. Each channel snugly receives one of the spokes along a substantial length of the channel.

### CROSS REFERENCE TO RELATED APPLICATIONS

This application derives and claims priority from U.S. provisional application 63/156656, filed 4 Mar. 2021, and having Attorney Docket No. PUSH F718US (22867.00004), which application is incorporated herein by reference.

### STATEMENT REGARDING FEDERALLY SPONSORED RESEARCH OR DEVELOPMENT

Not applicable.

### BACKGROUND OF THE INVENTION

This invention relates principally to a hub for locking a wheel, and more particularly to a lock plate assembly for a remotely operated wheel lock for a spoked wheelchair wheel.

The present disclosure comprises improvements to the disclosure presented in U.S. Pat. No. 6,341,671 to Ebersole for a WHEELCHAIR PARKING BRAKE (the '671 Patent), as well as improvements over the commercial version of the wheelchair parking brake disclosed and claimed in the '671 Patent. As explained in the '671 Patent: “Existing wheelchair wheel locks based on friction between a moveable portion of a brake, or lock, and the tire or wheel of the wheelchair suffer in effectiveness in that a limited area of contact between the brake and the wheel permit the wheel to slip and rotate under high lateral loads, such as during the egress of the wheelchair occupant from the wheelchair. It is desirable that wheelchair parking brake, or lock, should substantially preclude any further wheel rotation whatsoever, once engaged, nonetheless to being easy and reliable to engage and dis-engage.” (1:13-22). The '671 Patent discloses a wheelchair wheel lock system that, with limitations, overcomes such concerns.

That is, the wheelchair wheel lock system of the '671 Patent and the commercial wheelchair wheel lock systems that claim to be covered by the '671 Patent (collectively, the “Ebersole Plate Design”), incorporate several design features that adversely impact the operation and/or durability of the wheel lock system.

One such suspect design feature is the Ebersole Design's wheel lock plate assembly. This assembly consists of two flat and circular aluminum plates—a larger diameter plate with a set of radial through bores that releasably engage a retractable locking pin, and a second plate with a smaller diameter. These two plates are designed to coaxially attach to one another across the spokes of a wheelchair wheel with a set of screws positioned in a circular pattern that are directed through the smaller plate and threaded into the larger plate.

Unfortunately, it is well-known that operational forces cause wheelchair spokes to constantly flex under stress in directions generally transverse to the wheels. Because both Ebersole plates are constructed of rigid material (e.g., aluminum or steel), this design has a tendency for the screws to loosen due to the spoke components pressing against the plates as the spokes flex. Further, in an apparent attempt to address this spoke flex problem, the Ebersole design features a narrow inner plate with short, over-sized unidimensional grooves that engage the spoke components. These grooves each have substantially the same cross-section along their length, and that cross-section is sized and shaped to engage the spoke nipples, only, and not the spokes themselves. Thus, each of the Ebersole grooves can only contact and clamp down on the portion of the spoke nipple extending out from the wheel hub, at the very short inner portion of the groove nearest the hub of the wheel. This results in a very short contact length of typically only a few hundredths of an inch.

All of the short comings in the Ebersole design result in a set of focused stress points that facilitate the loosening of the plate screws and a pose a potential failure point for the spoke components due to wear. In addition, the

Ebersole design only has one set of screws positioned in a uniform ring about the outer plate. This severely limits the ability of the plates to withstand torques and forces imposed on the plates by the spokes, which further tends to allow the screws to loosen.

It would therefore be desirable to have a wheelchair wheel lock system that incorporates a wheel lock plate assembly that does not suffer the above-described deficiencies. As will become evident in this disclosure, the present invention provides such improvements over the existing art, and in particular, the wheel lock plate assembly of the Ebersole Design.

### BRIEF DESCRIPTION OF THE DRAWINGS

The illustrative embodiments of the present invention are shown in the following drawings which form a part of the specification:

FIG. 1 is a perspective view of a representative plate assembly for a spoked wheelchair wheel lock system incorporating one embodiment of the present invention;

FIG. 2 is a side view of the plate assembly of FIG. 1;

FIG. 3 is a cross-sectional side view of the plate assembly of FIG. 1;

FIG. 4 is an inner plan view of the plate assembly of FIG. 1;

FIG. 5 is an outer plan view of the plate assembly of FIG. 1;

FIG. 6 is an exploded perspective view of the plate assembly of FIG. 1;

FIG. 7 is a perspective view of two plate assemblies of FIG. 1, the plate assemblies being depicted operatively associated with a lock-pin actuation assembly and lever assembly for a wheelchair;

FIG. 8 is a perspective view of two plate assemblies of FIG. 1 attached to the spoked wheels of a representative wheelchair, the plate assemblies being depicted operatively associated with a lock-pin actuation assembly and lever assembly for a wheelchair, each attached to the wheelchair, the wheelchair being depicted as a phantom image of the frame and wheels;

FIG. 9 is an exploded perspective view one of the spring-loaded lock-pin assemblies of FIGS. 7 and 8;

FIG. 10 is a perspective view of a representative commercial embodiment of the plate assembly of the wheelchair wheel lock system disclosed in U.S. Pat. No. 6,341,671, showing the assembly attached to the spokes of a wheelchair wheel;

FIG. 11 is a magnified top view of a portion the two conjoined plates of FIG. 10, showing one of the channels or grooves with its corresponding spoke and nipple in cross-section;

FIG. 12 is a perspective view of a representative commercial embodiment of the wheelchair wheel lock system disclosed in U.S. Pat. No. 6,341,671, including the plate assembly of FIG. 10;

Corresponding reference characters indicate corresponding parts throughout the several views of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

In referring to the FIGS. 10-12 for background purposes, it can be seen that the wheel lock plate assembly of the Ebersole Design, referred to as E10, consists of a larger circular inner plate E12 attached to a smaller circular outer plate E14, positioned about the hub H and spokes S of a wheelchair wheel. Both plates E12 and E14 are constructed of a rigid metal such as stainless steel or aluminum. The outer plate E14 includes a set of radially-oriented oval-shaped through bores E16, each positioned near the outer edge of the outer plate E14. The inner plate E12 is rigidly attached to the outer plate E14 with a set of screws E18 that are positioned in a set of through bores E20 oriented in a single circle about the outer plate E14, and threaded directly into the inner plate E12. Accordingly, the Ebersole Design allows for very little flex between the screws E18. Unfortunately, it has been learned that during use, the wheelchair spokes flex extensively and repeatedly under the strain of their operational loads. This flexing imparts repeated forces that are transmitted from the spokes through the plates E12 and E14 and to the screws E18. These forces from the spokes can, over time, loosen the screws E18 in the plates E12 and E14 to result in a failure or otherwise dangerous condition for the assembly E10.

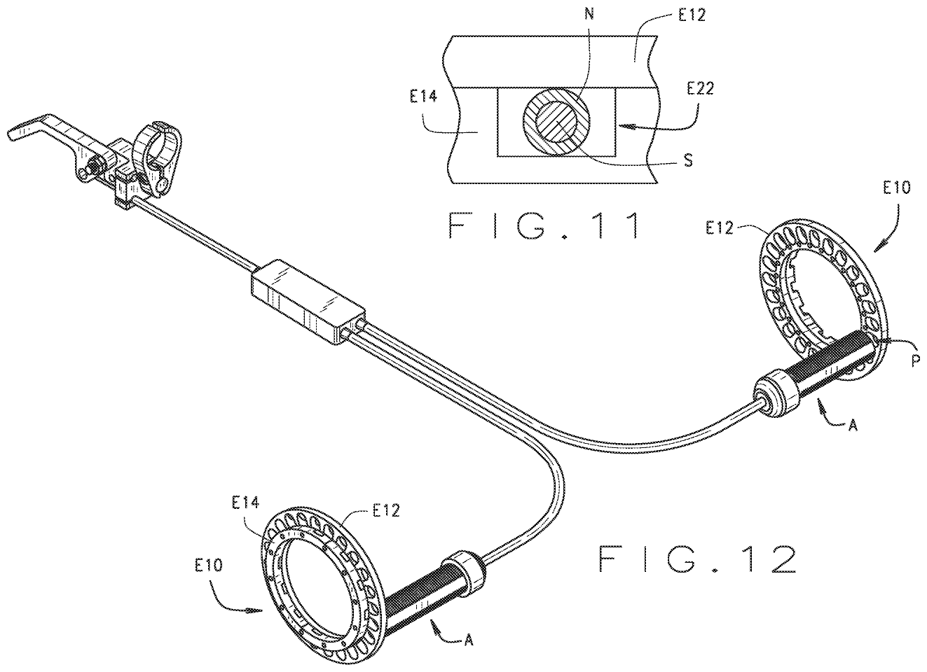

Further, and now referring particularly to FIGS. 10 and 11, it can be seen that the Ebersole outer plate E14 features a set of short, over-sized unidimensional grooves E22 that engage and clamp down on the spoke components to secure the Ebersole plate assembly to the wheelchair wheel about the wheel's hub. The grooves E22 each have a length of approximately ¼ inch (the radial width of the outer plate E14), and have substantially the same cross-section along their entire length. That cross-section is sized and shaped to engage the spoke nipples, only, and not the spokes themselves. Thus, each of the Ebersole grooves E22 can only contact and clamp down on the portion of the spoke nipple extending out from the wheel hub, at the very short inner portion of the groove E22 nearest the hub of the wheel. This results in a very short contact length of typically only a few hundredths of an inch.

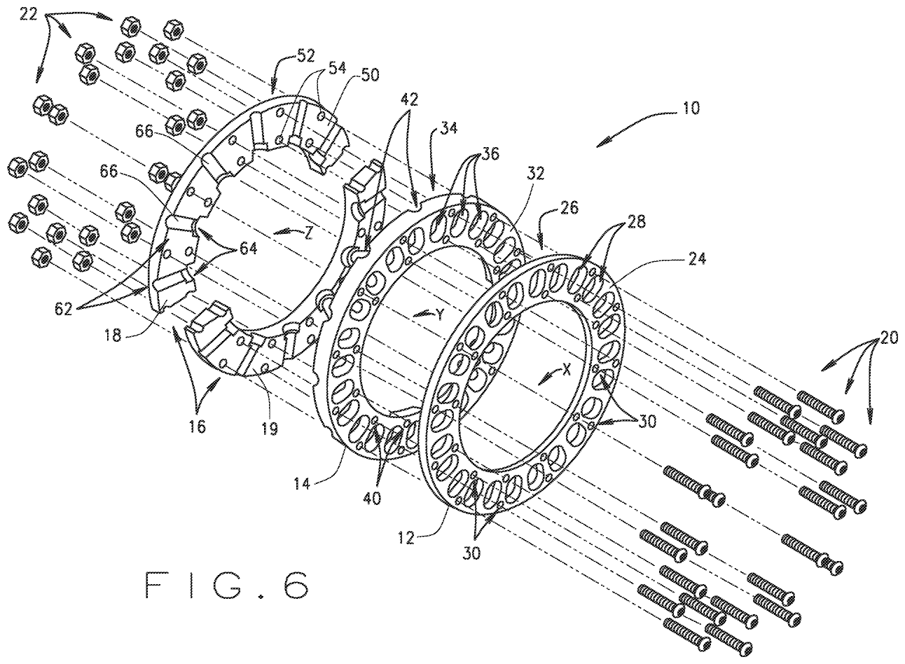

Referring now to FIGS. 1-6, a first representative embodiment of the present disclosure, generally referred to as a wheelchair wheel lock plate assembly 10, is shown generally by way of example. As can be seen, the plate assembly 10 has a ring-shaped lock plate or inner plate 12, a ring-shaped central plate 14 and a ring-shaped outer plate 16 that is formed with two matching semicircular halves or crescents 18 and 19. The inner plate 12 is constructed of a lightweight metal such as for example aluminum alloy, while the central plate 14 and the outer plate 16 are both constructed of a high-strength, elastic, slightly pliant polymer, such as for example Nylon-11. All of the plates 12, 14 and 16 are generally flat, and all share the same inner diameter of approximately 2.75 inches, and the same outer diameter of approximately 4.00 inches. The inner plate 12 has an overall thickness of approximately ¼ inch, the central plate 14 has an overall thickness of approximately ¼ inch, and the outer plate 16 has an overall thickness of approximately 3/16 inch. Of course, these dimensions can be altered to fit different wheelchairs with particular hub and spoke configurations. The plate assembly 10 further has a set of twenty-four identical steel machine screws 20 and twenty-four matching nylon machine screw lock nuts 22 that fit the screws 20.

The inner plate 12 has a first face 24 and a second face 26 that is opposite the first face 24. The faces 24 and 26 are parallel to and mirror each other. The inner plate 12 also has a central axis X perpendicular to the faces 24 and 26, and a set of twenty-four slightly flattened and radially aligned elliptical openings 28 that form a uniform circular pattern about the plate 12 that is coaxial with the axis X. The openings 28 are all identical, and have an overall length of approximately 0.440 inches and a central width of approximately 0.313 inches. The openings 28 are each arcuately equidistant from one other, and each opening 28 has a major axis of symmetry that coincides with a radius stemming from the central axis X. The openings 28 are each equidistant from the central axis X.

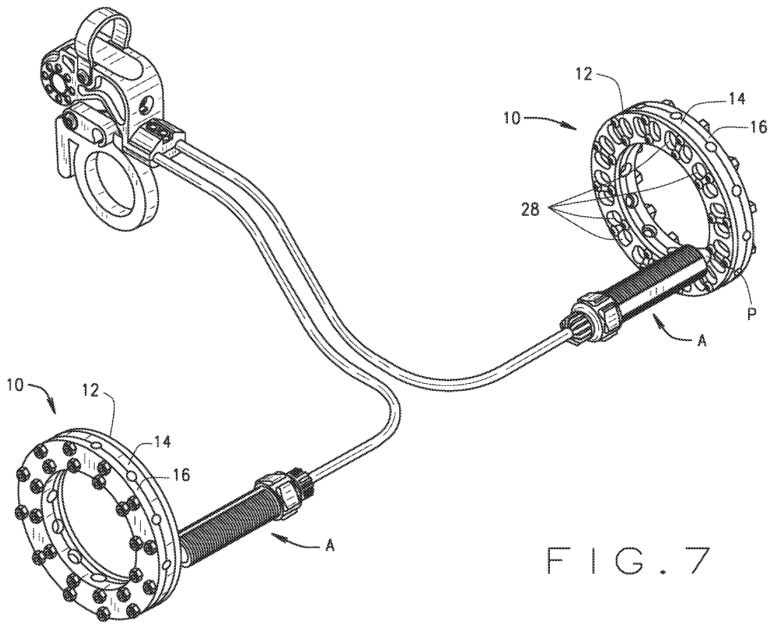

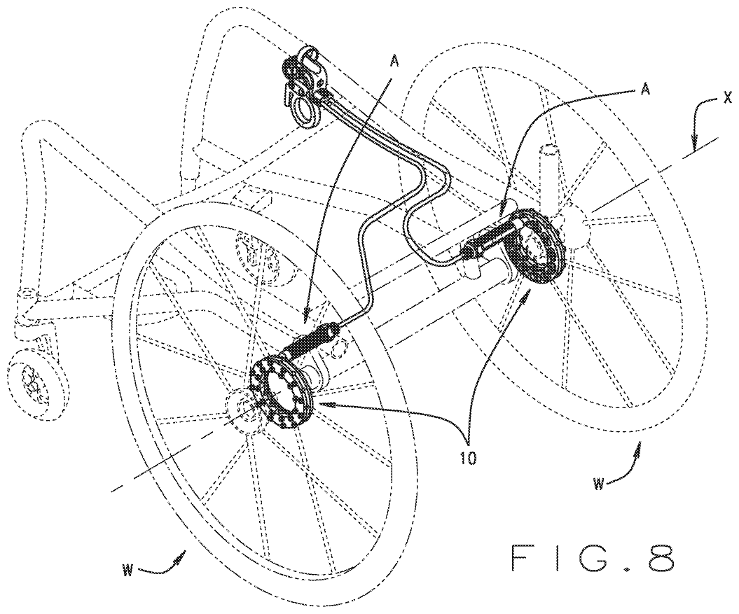

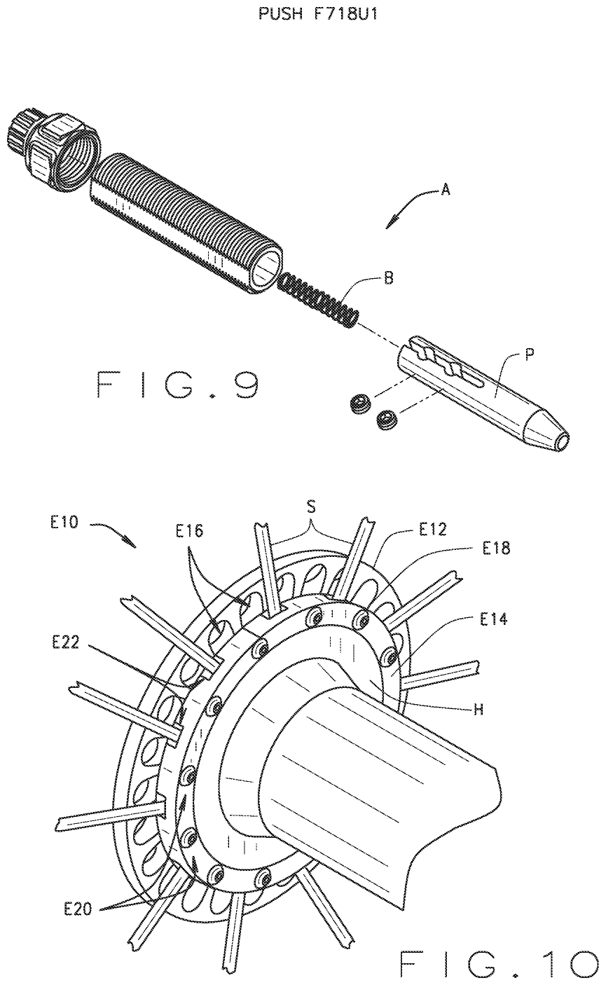

As can be seen from FIGS. 7-9, the wheelchair wheel lock system includes a lock-pin P that extends from a spring-loaded lock-pin assembly A, having a spring B. The assembly A is fixedly positioned next to the inner plate 12, which is secured to a spoked wheel W. The lock-pin P selectively and releasably engages whichever of the openings 28 is rotationally oriented nearest the lock-pin 28 at any given time, and thereby rotationally “locks” the plate 12. Hence, the lock-pin P prevents the rotation of the plate 12, and hence the spoked wheel W, about the axis X when the lock-pin P is engaged with any one of the openings 28. Disengaging the lock-pin P from the openings 28 no longer restricts the plate 12, and hence the wheel W, from rotating about the axis X.

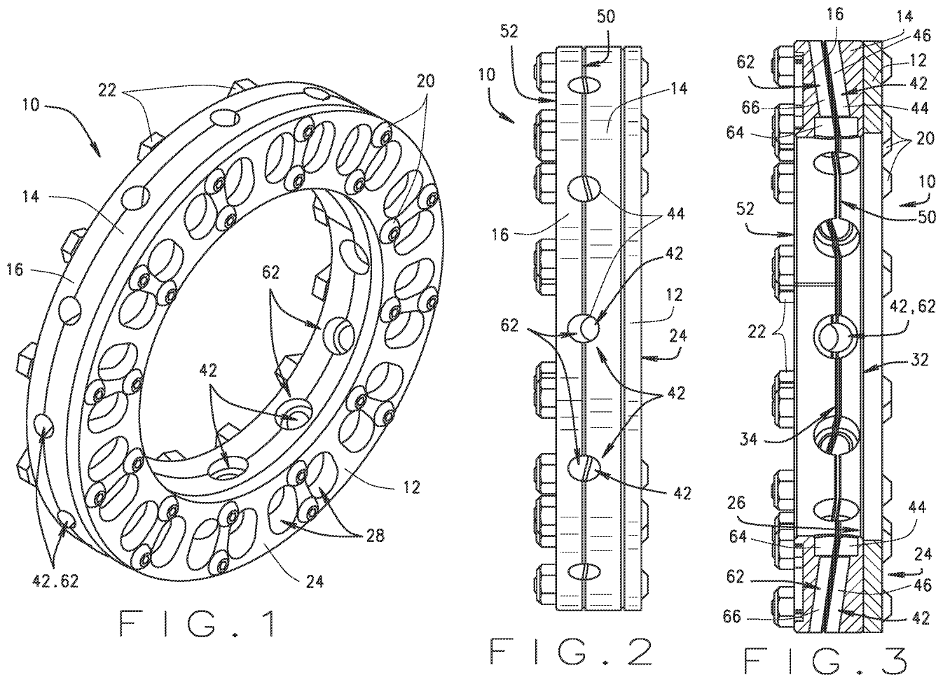

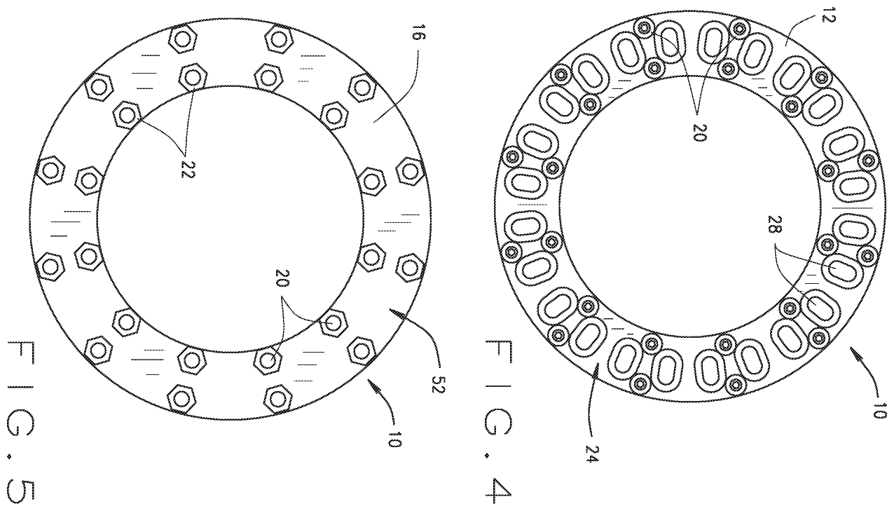

Referring again to FIGS. 1-6, the inner plate 12 further has twenty-four perpendicular through bores 30 that are positioned in radial pairs spaced arcuately equidistant from each other to form two concentric circles of bores positioned about the inner plate 12, with the smaller circle having a radius of approximately 1.47 inches and the larger circle having a radius of approximately 1.89 inches. The bores 30 are all identical, with a uniform diameter sized to slidingly accommodate the stems of the screws 20. The bores 30 that form the inner concentric circle are spaced approximately 0.76 inches apart arcuately, while the bores 30 that form the outer concentric circle are spaced approximately 0.98 inches apart arcuately. The arcuate spacing between the bores 30 is sufficient to accommodate the positioning of two openings 28 between each set of bores 30, and the openings 28 and the bores 30 are rotationally aligned with each other about the axis X to accommodate the uniform and centered positioning of pairs of openings 28 between pairs of bores 30. This orientation and spacing of the bores 30 is replicated in each of the plates 14 and 16. The central plate 14 has a first face 32 and a second face 34 that is opposite the first face 32. The first and second faces 32 and 34 are generally parallel to each other, but as seen in FIGS. 2 and 3, the outer edge of the central plate 14 is thicker than the plate's inner edge, such that the second face 34 has a uniform slope of approximately 9 degrees from its outer perimeter to its inner perimeter so as to relatively closely match the slope of the wheelchair wheel spokes relative to the wheel's central axis, such as for example, wheelchair wheels manufactured under the trade name Spinergy®.

The central plate 14 also has a central axis Y perpendicular to the faces 32 and 34. A set of twenty-four radially positioned, slightly flattened elliptical openings 36 form a uniform circular pattern about the plate 14 that is coaxial with the axis Y. The openings 36 mate with corresponding openings 28 in the inner plate 12. The openings 36 are all identical, each having at the first face 32 a length of approximately 0.440 inches and a width of approximately 0.313 inches, while at the second face 34, each opening 36 has a length of approximately 0.280 inches and a width of approximately 0.150 inches, such that the openings 36 uniformly taper down in size from the first face 32 to the second face 34 of the inner plate 14. Mimicking the openings 28 in the inner plate 12, the openings 36 are each laterally equidistant from one other, and each opening 36 has a major axis of symmetry that coincides with a radius stemming from the central axis Y. The openings 36 are each equidistant from the central axis Y.

The central plate 14 further has twenty-four perpendicular through bores 40 that mate with the bores 30 in the inner plate 12. Corresponding to the bores 30, the bores 40 are positioned in radial pairs spaced arcuately equidistant from each other to form two concentric circles coaxial with the axis Y and positioned about the central plate 14, with the smaller circle having a radius of approximately 1.47 inches and the larger circle having a radius of approximately 1.89 inches. The bores 40 are all identical, with a uniform diameter sized to slidingly accommodate the stems of the screws 20. The bores 40 that form the inner concentric circle are spaced approximately 1.47 inches apart arcuately, while the bores 40 that form the outer concentric circle are spaced approximately 1.89 inches apart arcuately. The arcuate spacing between the bores 40 is sufficient to accommodate the positioning of two openings 36 between each set of bores 40, and the openings 36 and the bores 40 are rotationally aligned with each other about the axis Y to accommodate the uniform and centered positioning of pairs of openings 36 between pairs of bores 40.

The second face 34 of the central plate 14 includes a set of twelve generally equidistantly-spaced radial channels or grooves 42 that are shaped and oriented to fit snugly over the wheel spokes nipples and a portion of the spokes themselves, for various wheelchair wheels. That is, as one of ordinary skill in the art will recognize, depending on the particular design of the wheel, such as for example Spinergy® brand wheels, the wheel's spokes and nipples can radiate outward from the central hub of the wheel at slightly different directions and at slightly different angles. Applicant's design contemplates producing variants of the disclosed wheel lock assembly in which the grooves 42 are configured to match the spokes and nipples for differing wheel configurations. As previously mentioned, the Ebersole design compensates for this by forming a uniform and oversized groove E22 in is smaller outer plate E14 so as to accommodate spokes radiating from the hub in a variety of directions and angles. This only allows the Ebersole groove E22 to engage the spoke nipples, and not the spokes themselves, in a very confined portion or length of the groove E22 near the hub. In contrast, each of the grooves 42 is shaped and sized to match the orientation and radial angle of its corresponding spoke, and to snugly receive that spoke in the groove 42 along the length of the groove 42.

Each groove 42 has a short deep semi-cylindrical segment or neck 44 and a longer shallow segment 46. The neck 44 and shallow segment 46 are both semi-cylindrical in cross-section, and coaxial along their lengths. The neck 44 is positioned at the inner edge of the plate 14, and has a depth or radius of approximately 0.125 inches, and a length of approximately 0.125 inches, which corresponds closely to the shape of the nipple in a Spinergy® brand wheel. Each shallow segment 46 extends radially outward from the outer edge of its corresponding neck 44 to the outer edge of the plate 14, has a depth or radius of approximately 0.096 inches, and a length of approximately 0.519 inches, which corresponds closely to the shape of the spokes on a Spinergy® brand wheel.

Turning now to the outer plate 16. When the crescents 18 and 19 are properly oriented and positioned together as shown in FIGS. 1-3 and 6, they collectively form the outer plate 16. The outer plate 16 has a first face 50 and a second face 52 that is opposite the first face 50. The outer plate 16 first face 50 and second face 52 are generally parallel to each other, but as seen in FIGS. 2 and 3, the outer edge of the outer plate 16 is thinner than the plate's inner edge, such that the first face 50 has a uniform slope of approximately 9 degrees from its outer perimeter to its inner perimeter so as to relatively closely match the slope of the Spinergy® brand wheelchair wheel spokes relative to the wheel central axis, and to allow the first face 50 of the outer plate 16 to fully mate with the second face 34 of the central plate 14.

The outer plate 16 also has a central axis Z perpendicular to the faces 50 and 52. Twenty-four perpendicular through bores 54 that mate with the bores 40 in central plate 14 and the bores 30 in inner plate 12. Corresponding to the bores 40 and 30, the bores 54 are positioned in radial pairs spaced laterally equidistant from each other to form two concentric circles that are both coaxial with the axis Z and positioned about the outer plate 16, with the smaller circle having a radius of approximately 1.47 inches and the larger circle having a radius of approximately 1.89 inches. The bores 54 are all identical, with a uniform diameter sized to slidingly accommodate the stems of the screws 20. The bores 54 that form the inner circle of bores are spaced approximately 1.47 inches apart arcuately, while the bores 54 that form the outer circle of bores are spaced approximately 1.89 inches apart arcuately.

The second face 52 of the outer plate 16 is flat. However, the first face 50 of the outer plate 16 includes a set of twelve generally equidistantly-spaced radial channels or grooves 62 that are shaped and oriented to fit snugly over the wheel spokes for a particular wheelchair wheel, and mate as mirrors to the grooves 42 in the outer surface 34 of the central plate 14. As with each groove 42, each matching groove 62 has a short deep semi-cylindrical segment or neck 64 and a longer shallow segment 66. The neck 64 and shallow segment 66 are both semi-cylindrical in cross-section, and coaxial along their lengths. The neck 64 is positioned at the inner edge of the plate 16, has a depth or radius of approximately 0.125 inches, and a length of approximately 0.125 inches. Each shallow segment 66 extends radially outward from the outer edge of its corresponding neck 64 to the outer edge of the plate 16, and has a depth or radius of approximately 0.096 inches, and a length of approximately 0.519 inches.

Referring now to FIG. 1, it can be seen that the plates 12, 14 and 16 have a particular assembly configuration. That is, the second face 26 of the inner plate 12 is positioned against the first face 32 of the central plate 14, and the second face 34 of the central plate 14 is positioned against the inner face 60 of the outer plate 16. Further, the plates 12, 14 and 16 are positioned to form a unitized plate or ring with each of the plates 12, 14 and 16 rotationally oriented to align the bores 30 with their corresponding bores 40, and align the bores 40 with their corresponding bores 54, all as shown. Each of the screws 20 is then pushed from the first face 24 of the inner plate 12 through one of the now-aligned sets of bores 30, 40 and 54, such that the threaded end of each such screw 20 extends from the second face 52 of the outer plate 16. Each of the screws 20 is then secured by a lock nut 22, and all of the lock nuts 22 are tightened to hold the plates 12, 14 and 16 together in this desired configuration, forming a complete plate assembly 10.

This will result in each of the openings 28 aligning with its corresponding opening 36, and each of the grooves 42 aligning with its corresponding groove 62, as can be appreciated. Further, the axes X, Y and Z will all be colinear.

Particular polymers and other similar materials, including the polymer Nylon-11 used to construct the central plate 14 and the outer plate 16, have inherent physical properties, including flexibility and resiliency, that enable the material to absorb localized impact forces and vibrations, and return substantially to original form without permanent distortion and to thereby limit the transfer of such forces to the region proximate the point of impact with the force. That is, such materials have force dampening attributes. Thus, as can be appreciated from this disclosure, constructing the plates 14 and 16 from the polymer Nylon-11 (or a polymer or other material with similar resilient properties), and attaching the inner plate 12 to these plates 14 and 16, provides for localized resilience in the material to the forces imposed on the plates 14 and 16 due to the repetitive flexing of the wheelchair spokes during use. This reduces the tendency for the screws 20 to loosen due to the stresses imposed on the plate assembly 10 by the wheelchair spokes during use.

Moreover, the present design also features a double circle of screws 20, as opposed to the single row/circle of screws E16 in the Ebersole Design. This double-row/circle configuration distributes clamping loads from the screws 20 across more area of the plates 12, 14 and 16, which thereby further reduces the likelihood that that the screws 20 will loosen due to stresses imposed on the plate assembly 10 by the wheelchair spokes during use.

Finally, the screws 20 in the plate assembly 10 are not threaded directly into the plate that engages the lock-pin (i.e., inner plate 12) as in the Ebersole Design. Rather, the screws 20 are secured with the lock nuts 22, which each have a body of nylon that engages the threads of the screws 20. Again, the nylon acts as an additional cushion to dampen forces or vibrations from the spokes that could otherwise tend to loosen the screws 20 due to stresses imposed on the plate assembly 10 by the wheelchair spokes during use.

While I have described in the detailed description a configuration that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel plate assembly 10 of the present invention can be arranged in a number of other and related varieties of configurations without expanding beyond the scope of our invention as set forth in the claims.

For example, the shape and orientation of the grooves 42 and their corresponding grooves 62 can be varied so as to ensure a snug fit on the spokes of wheelchairs having different spoke configurations. Further, the grooves 42 and the grooves 62 can both be altered such that the grooves 42 receive more or less of a portion of the body of the spokes, while the grooves 62 receive a corresponding portion of the body of each spoke. At the extreme, the grooves 42 could fully receive the wheel spokes and eliminate the need for the grooves 62, or vice versa.

In addition, while the inner plate 12 is depicted with twenty-four elliptical openings 28 spaced arcuately equidistant from each other, it is contemplated that the plate 12 may comprise different numbers of openings 28 for different applications. For example, the plate 12 may have twelve or eighteen such openings 28. However, the plate 12 may have as few as one opening 28, or more than twenty-four. In addition, the openings 28 need not be equidistantly spaced from one another. There simply needs to be at least one opening 28 for a lock-pin P to engage. Similarly, the openings 28 need not all be elliptical in shape, nor even uniform in size or shape between them, so long as the openings 28 allow for engagement with the tip of the lock-pin P.

In addition, while the inner plates 12, 14 and 16 are depicted with twenty-four corresponding and aligning through bores 30, 40 and 54, that are positioned in radial-spaced pairs arcuately equidistant from each other to form two concentric circles of bores positioned about the plates 12, 14 and 16, it is contemplated that the plates may comprise different numbers of pairs or sets of through bores 30, 40 and 54 for different applications. For example, two alternate versions of the plates 12, 14 and 16 have been designed by the Applicant to have twelve and eighteen matched pairs of through bores 30, 40 and 54. In addition, the plates may comprise through bores 30, 40 and 54 that form more than two concentric circles of bores. Thus, the plates 12, 14 and 16 may have more or less such through bores 30, 40 and 54, and the through bores 30, 40 and 54 need not form matched pairs and need not be equidistantly spaced from one another, so long as the through bores 30, 40 and 54, combined with their corresponding screws 20 and nuts 22 provide sufficient strength to secure the plates 12, 14 and 16 together.

In addition, the plates 12, 14 and/or 16 may be attached or secured together with means or fasteners other than the screws 20 and associated lock nuts 22. For example, the lock washers and standard nuts may be used with the screws 20 instead of the lock nuts 22. Similarly, the plate 1 can be tapped to accommodate the threading of the screws 20 into the plate 16 without the lock nuts 22. It is also possible, for example, to utilize clamps that secure both the inner and outer perimeters of the plates 12, 14 and 16 together.

By way of further example, the plates 12, 14 and/or 16 need not have the exact circular shapes or diameters as depicted in the plan view Figures, but any one or more of said plates 12, 14 and/or 16 could be any variety of shapes, such as for example hexagonal, elliptical, octagonal or simply irregular, so long as the plates can be assembled together to provide the functionality as described herein.

In addition, the plates 12, 14 and 16 need not have the specific thickness disclosed herein, but each may vary in thickness so long as the plates can be assembled together to provide the functionality as described herein.

Also, as discussed above, alternatively, the collective shapes and orientation of the grooves 42 and 62 can be varied so as to ensure a snug fit, as described herein, on the spokes of wheelchairs having different spoke configurations.

It is also contemplated by the Applicant that the grooves 42 can be formed in pliant inserts that are embedded in the plate 14. Similarly, the grooves 62 can be formed in pliant inserts that are embedded in the plate 16. It is also contemplated that, while preferably the plates 14 and 16 are both formed of a pliant material such as Nylon-11, nonetheless either of the plates 14 or 16 can be constructed of a pliant material to provide the cushioning effect, albeit a more limited amount of cushioning, about the spokes as described herein.

Moreover, the second face 52 of the outer plate 16 may include a hex-shaped detent or depression for each of the bores 54 that is shaped to snugly receive one of the lock nuts 22. Alternately, the first face 24 of the inner plate 12 may include a hex-shaped detent or depression for each of the bores 30 that is shaped to snugly receive the head of the bolt 30. In either case, the detent or depression provides a mechanism to secure the plates 12, 14 and 16 together by tightening from only one end of the bolt 20 and lock nut 22 combination, and minimizes the potential for the lock nuts 22 to work free from the bolts 20.

Additional variations or modifications to the configuration of the above-described novel plate assembly 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. A plate assembly for a spoked wheel wheelchair wheel lock system, said wheelchair having a spoked wheel comprising a hub and a plurality of spokes extending radially from said hub, each of said spokes having a nipple engaging said spoke and said hub, said wheel lock system comprising a lock-pin positioned proximate said spoked wheel, said lock-pin positioned and oriented to controllably move between a first position in which said lock-pin extends toward said wheel and a second position in which said lock-pin retracts from said wheel, said plate assembly comprising:
a. a substantially rigid and generally flat fist plate, said first plate attaching to said spoked wheel about said hub proximate said lock-pin when said lock-pin is properly positioned on said wheelchair, said first plate having an engagement element, said engagement element engaging said lock-pin when said lock-pin is situated in its said first position and said first plate is rotated about said hub so as to orient said engagement element with said lock-pin;
b. a substantially rigid and generally flat second plate, said second plate being shaped and sized to mate with and attach to said first plate; and
c. a plurality of fasteners, said fasteners collectively attaching said second plate to said first plate.
said first and second plates mating to each other on opposing sides of said wheel to collectively form a plurality of elongated radial channels, at least one of said plurality of channels being shaped and sized and oriented in said plates to snugly receive at least in part one of said plurality of wheel spokes.

1. The plate assembly of claim 1, wherein said at least one of said plurality of channels snugly receives at least in part a nipple associated with said one of said plurality of wheel spokes.

2. The plate assembly of claim 1, wherein said at least one of said plurality of channels snugly receives one of more of said one of said plurality of wheel spokes and its associated nipple along a collective length greater than one quarter inch.

3. The plate assembly of claim 1, wherein at least one of said first and second plates comprises at least in part a pliant material proximate at least one of said channels.

4. The plate assembly of claim 1, wherein said first plate assembly comprises a first plurality of fastener sites and a second plurality of fastener sites for the fastening together of said first and second plates, said first plurality of fastener sites being positioned between a first radius and a second radius about said hub when said plate assembly is attached to said wheel, said second radius being greater than said first radius, said second plurality of fastener sites being positioned between said second radius and a third radius about said hub when said plate assembly is attached to said wheel, said third radius being greater than said second radius.

5. The plate assembly of claim 1, further comprising a substantially rigid and flat third plate, said third plate attaching to one of said first and second plates, said engagement element being positioned in said third plate.

6. The plate assembly of claim 5, wherein one of said second and third plates comprises at least in part a pliant material proximate at least one of said elongated radial channels.

7. The plate assembly of claim 1, further comprising a first plurality of fasteners and a second plurality of fastener sites for the fastening together of said first and second plates, said first plurality of fastener sites being positioned between a first radius and a second radius about said hub when said plate assembly is attached to said wheel, said second radius being greater than said first radius, said second plurality of fastener sites being positioned between said second radius and a third radius about said hub when said plate assembly is attached to said wheel, said third radius being greater than said second radius.

8. The plate assembly of claim 7, wherein said plurality of fasteners comprises a plurality of bolts and a plurality of matching nuts, at least one of said plurality of nuts comprising a pliant material, and wherein at least one of said plurality of bolts extends through at least two of said plates to be secured with one of said matching nuts comprising a pliant material

9. A plate assembly for a spoked wheel wheelchair wheel lock system, said wheelchair having a spoked wheel comprising a hub and spokes extending radially from said hub, said spoked wheel comprising a plurality of spokes, said wheel lock system comprising a lock-pin positioned proximate said spoked wheel, said lock-pin positioned and oriented to controllably move between a first position in which said lock-pin extends toward said wheel and a second position in which said lock-pin retracts from said wheel, said plate assembly comprising:
a. a generally flat fist plate, said first plate attaching to said spoked wheel about said hub proximate said lock-pin when said lock-pin is properly positioned on said wheelchair, said first plate having an engagement element, said engagement element engaging said lock-pin when said lock-pin is situated in its said first position and said first plate is rotated about said hub so as to orient said engagement element with said lock-pin;
b. a generally flat second plate, said second plate being shaped and sized to mate with and attach to said first plate; and
c. a plurality of fasteners, said fasteners collectively attaching said second plate to said first plate.
said first and second plates mating to each other on opposing sides of said wheel to collectively form a plurality of elongated radial channels, at least one of said channels being shaped and sized and oriented in said plates to receive at least in part one of said wheel spoke nipples, one of said first and second plates comprising at least in part a pliant material proximate said at least one of said channels.

10. The plate assembly of claim 9, wherein both of said first and second plates comprise a pliant material proximate at least one of said channels.

11. The plate assembly of claim 9, further comprising a substantially rigid and flat third plate, said third plate attaching to one of said first and second plates, said engagement element being positioned in said third plate.

12. The plate assembly of claim 9, wherein at least one of said elongated radial channels is shaped and sized and oriented in said plates to snugly receive at least in part one of said plurality of wheel spokes.

13. The plate assembly of claim 9, wherein one of said first and second plates comprises an insert positioned on or in said plate, said insert comprising at least a portion of one of said plurality of elongated radial channels, said insert comprising a pliant material.

14. The plate assembly of claim 9, further comprising a first plurality of fasteners and a second plurality of fastener sites for the fastening together of said first and second plates, said first plurality of fastener sites being positioned between a first radius and a second radius about said hub when said plate assembly is attached to said wheel, said second radius being greater than said first radius, said second plurality of fastener sites being positioned between said second radius and a third radius about said hub when said plate assembly is attached to said wheel, said third radius being greater than said second radius.

15. The plate assembly of claim 14, wherein said plurality of fasteners comprises a plurality of bolts and a plurality of matching nuts, at least one of said plurality of nuts comprising a pliant material.

16. A plate assembly for a spoked wheel wheelchair wheel lock system, said wheelchair having a spoked wheel comprising a hub and spokes extending radially from said hub, said spoked wheel comprising a plurality of spokes, said wheel lock system comprising a lock-pin positioned proximate said spoked wheel, said lock-pin positioned and oriented to controllably move between a first position in which said lock-pin extends toward said wheel and a second position in which said lock-pin retracts from said wheel, said plate assembly comprising:
a. a substantially rigid and generally flat fist plate, said first plate attaching to said spoked wheel about said hub proximate said lock-pin when said lock-pin is properly positioned on said wheelchair, said first plate having an engagement element, said engagement element engaging said lock-pin when said lock-pin is situated in its said first position and said first plate is rotated about said hub so as to orient said engagement element with said lock-pin;
b. a substantially rigid and generally flat second plate, said second plate being shaped and sized to mate with and attach to said first plate;
c. a first plurality of fastener sites for the fastening together of said first and second plates, said first plurality of fastener sites being positioned between a first radius and a second radius about said hub when said plate assembly is attached to said wheel;
d. a second plurality of fastener sites for the fastening together of said first and second plates, said second plurality of fastener sites being positioned between said second radius and a third radius about said hub when said plate assembly is attached to said wheel, said third radius being greater than said second radius; and
e. a plurality of fasteners, said fasteners being positioned in said first and second fastener sites to collectively attach said second plate to said first plate;
said first and second plates mating to each other on opposing sides of said wheel to collectively form a plurality of elongated radial channels, at least one of said channels being shaped and sized and oriented in said plates to receive at least in part one of said wheel spoke nipples.

17. The plate assembly of claim 16, wherein one of said first and second plates comprises a pliant material.

18. The plate assembly of claim 16, wherein one of said first and second plates comprises an insert positioned on or in said plate, said insert comprising at least a portion of one of said plurality of elongated radial channels, said insert comprising a pliant material.

19. The plate assembly of claim 16, further comprising a substantially rigid and flat third plate, said third plate attaching to one of said first and second plates, said engagement element being positioned in said third plate.

20. The plate assembly of claim 16, wherein at least one of said elongated radial channels is further shaped and sized and oriented in said plates to snugly receive one of said plurality of wheel spokes.
